(19) United States
(12) Patent Application Publication
(10) Pub. No.: US 2018/0013301 A1
(43) Pub. Date: Jan. 11, 2018

(54) HEAT-RESISTANT MOBILE DEVICE CHARGING CABLE

(71) Applicant: Stephan Young, Jacksonville Beach, FL (US)

(72) Inventor: Stephan Young, Jacksonville Beach, FL (US)

(21) Appl. No.: 15/491,966

(22) Filed: Apr. 19, 2017

Related U.S. Application Data
(63) Continuation-in-part of application No. 14/146,657, filed on Jan. 2, 2014, now abandoned.
(60) Provisional application No. 61/822,432, filed on May 12, 2013.
(60) Provisional application No. 61/748,143, filed on Jan. 2, 2013.

(51) Int. Cl. H02J 7/00

(52) U.S. Cl. CPC H02J 7/0044; H02J 7/0054; H02J 7/007

(57) ABSTRACT

The invention relates to a heat-resistant cable for charging a mobile device from a vehicle. In particular, the cable can be used to connect to a power source on a vehicle that does not have a standard cigarette lighter power source. The complete cable can be constructed as a single, continuous, and electrically sealed apparatus, without further interconnections open to the environment between the source connector and the output connector.

### RELATED APPLICATIONS

This application is a continuation-in-part of application Ser. No. 14/146,657, filed Jan. 2, 2014, which claims the benefit of U.S. Provisional Application No. 61/748,143, filed Jan. 2, 2013, and which also claims the benefit of U.S. Provisional Application No. 61/822,432, filed on May 12, 2013, the contents of each of which are hereby incorporated by reference.

### FIELD OF THE INVENTION

The present invention relates generally to an apparatus for providing electrical power to a mobile device from a battery or other power source on a vehicle through heat-resistant cabling.

### BACKGROUND OF THE INVENTION

Presently existing systems for charging mobile devices from various types of vehicles are limited in that they are unsuitable for use in a wide variety of environments. For example, the cabling on existing charging systems is typically not heat- or water-resistant. Furthermore, existing charging systems are cumbersome and difficult to connect to power supplies on the vehicles.

### BRIEF DESCRIPTION OF THE DRAWINGS

The following figures illustrate example embodiments of the invention and are not intended to be limiting of the scope of the invention. While one or more embodiments of the present invention have been described, various alterations, additions, permutations and equivalents thereof are included within the scope of the invention.

FIG. 1 illustrates a design overview schematic for converting a 12V source to a 5V output.

FIG. 2 illustrates a design overview schematic for receiving input power by a Battery Tender™ connection and output to a USB connection.

FIG. 3 illustrates a cable connection at the 12V source terminating in a flat-two pin SAE connector.

FIGS. 4-6 illustrate a printed circuit board attached proximate to the flat-two pin SAE connector proximate to the source end of the cable.

FIGS. 7-12 illustrates a source end comprising a flat two-pin SAE connector for connection to the wiring harness.

FIG. 13 illustrates a source end comprising a flat two-pin SAE connector for connection to the wiring harness, showing placement of a circuit board and example dimensions.

FIG. 14 illustrates an output end formed as a USB B connector, showing example dimensions.

FIG. 15 illustrates a parts diagram showing construction for a cable with a flat two-pin SAE connector for connection to a 12V source and terminating in iPhone 4 connector.

FIG. 16 illustrates a parts diagram showing construction for cable with a flat two-pin SAE connector for connection to a 12V source and terminating in iPhone 5 connector.

FIG. 17 illustrates a parts diagram showing construction for cable with a flat two-pin SAE connector for connection to a 12V source and terminating in a mini-USB connector.

FIGS. 18A-B illustrate a specification for an example four conductor USB cable.

FIG. 19 illustrates an assembly view of the printed circuit board for power conversion.

FIG. 20 illustrates an example parts list for the printed circuit board having a mini-USB connection.

FIG. 21 illustrates an example circuit diagram for the converting the 12V source to the 5V output.

FIG. 22 illustrates an example completed cable having a mini-USB connector at the output.

### DETAILED DESCRIPTION

The invention disclosed herein relates to a heat-resistant cable for charging a mobile device from a vehicle. In particular, the cable can be used to connect to a power source on a vehicle that does not have a standard cigarette lighter power source. As non-limiting examples, the cable could be used with a motorized vehicle, water craft, motorcycle, ATV, scooter, jet ski, or snowmobile. The invention could be used with any type of sport vehicle or other type of vehicle. The cable could also be used with a vehicle that has a standard cigarette lighter power source. While some of the preferred embodiments of the invention are particularly suited for use on vehicles, the cable could be used as a power converter with stationary power sources as well.

In preferred embodiments, the charging cable can be used on a vehicle that presents a 12V electrical system. In a preferred embodiment, the charging cable can be 3.5 ft. in length (3′ 6″). Other lengths of cable could be used, such as 4.0 ft., or any other length. As illustrated below, the components can include a source connector, a power converter, and an output connector. In a preferred embodiment, the complete cable is constructed as a single, continuous, and electrically sealed apparatus, without further interconnections open to the environment between the source connector and the output connector.

On the source end, the cable can connect to a wiring harness that has been or can be attached to terminals on the vehicle battery. In some embodiments, this connection may be performed by a standard SAE connection. In some example embodiments, the output end can be a standard USB A or B connector, or any type of iPhone™ connector, or other mobile device charging connector. The output end can connect to a user's phone or tablet to charge the device. Alternatively, the output end can be used for any other purpose for which the output form factor and power specifications are appropriate. As described in more detail below, the cable can include an integrated printed circuit board (PCB) for performing the power conversion.

In some example embodiments, the source end can be molded using a Macromelt OM0657-I3. The cable can include a para-aramid synthetic fiber runner, such as Kevlar™ along the length of the cable and/or on the connector leads attached to the printed circuit board. The connectors, such as the USB mini-B connector, can be molded using Estane 58202-compound and a para-aramid synthetic fiber runner attached to the connector housing. In some example embodiments, the materials can be selected and the cable constructed so as to withstand a pull force of approximately 100 lbs. without breaking.

Source End

In some embodiments, the source end of the cable can interconnect to a wiring harness manufactured by Deltran, such as the Battery Tender™ harness. In some embodiments, the source end of the cable can be connected with other battery tender-type connections, such as any connector that would be used with another type of trickle charger.

Some embodiments can include an integrated fuse. The fuse can be located at any point along or in the cable or integrated into the PCB.

In some embodiments, the source end can be a flat SAE hermaphrodite two-conductor connector and the output end can be a micro USB connector. Molded into the cabling, proximate to the source end at the SAE connector can be DC/DC converter electronics. In some embodiments, over-molding can extend from the SAE connector to slightly past the PCB.

Variable Voltage Conversion

Some embodiments of the invention can include circuitry embedded in the cable to take a variable input voltage and output a stable voltage. In some embodiments, the converter can be isolated. One of the parameters of the isolated DC-DC converter is the range of the input voltage over which the converter can operate. In the industry-standard for the nominal 5V input mobile device marketplace, this is usually 12V to 5V, or a ratio of about 2:1 from the highest to the lowest value. But there are many applications where the inventive converter can handle a much wider range of input voltage variation and is desirable. For instance, in some cases the input voltage is significantly higher.

The inventive variable input voltage DC-DC converter can over a wide input voltage range and thereby effectuate a “universal” product that can be used in different host systems. Instead of having to produce three different versions of a product to work off a nominal 12V, 36V, and 48V sources, the inventive converter can operate from 12V to 48V and permits a single solution, with significant conveniences for the user.

It is known that the wider the operational input voltage range, the worse the converter's performance. Generally, both the converter's efficiency and the amount of power it can handle in a given size is reduced. This is the natural consequence of having to design for the highest input voltage while at the same time needing to handle the very large input current that results when the input voltage is at its lowest. For a converter that handles a 2:1 input range, the product of this maximum voltage and maximum current is twice that of the power being processed— a penalty, but one that can be accepted as a reasonable compromise. But in the case of a converter designed to handle an 9:1 input voltage range, such as 48V to 5V, the product is now nine times the processed power, and the penalty is extreme. This is most severely felt by the power circuitry associated with the isolation transformer of the converter. The inventive converter incorporates a number of design criteria relating to the level of isolation required, the tolerable voltage fluctuations that the architecture can withstand, and the types of protections that are made be available.

The input of the DC-DC converter is tied to the output of an upstream supply in the power system. This defines the required input voltage necessary for the DC-DC converter. There are a number of different input options depending on the stability of the voltage. For example, a fixed input voltage can be used when the voltage rail connected to the input is very stable. If, on the other hand, the DC-DC converter is connected to a fluctuating supply, like a battery, then a much wider input range is required to account for the changing input voltage conditions. 2 to 1 and 4 to 1 type inputs are examples of wide input range devices used to address applications with a volatile input voltage. These numbers represent a comparison between the high and low input voltage limits. An example of a 2 to 1 input voltage device would be a DC-DC converter that has a nominal input of 12 volts but can operate anywhere between 9 volts and 18 volts while still maintaining a stable output voltage.

The inventive DC-DC converter can be used to step down a voltage, step up a voltage, or invert a voltage from positive to negative. Which of these solutions is selected will depend on the type of load being driven and the power architecture of the design. The most common application is to step down the DC voltage from a higher voltage to a lower voltage.

The DC-DC converter can be implemented to provide isolation in a system. This electrical separation creates a barrier which can be used for safety protection or noise isolation. Two isolation factors can be specified: isolation resistance and isolation voltage. The isolation resistance is a function of the material and spacing employed in the DC-DC converter. The isolation voltage is defined as the maximum voltage across the isolation barrier that a device can withstand for a fixed time period. The required isolation voltage will depend on the market the device is being used in.

The DC-DC converter can be operated as a regulated or non-regulated device. Regulation is the ability of the DC-DC converter to maintain the output voltage within a specified range as input conditions change. A regulated DC-DC converter can be used in applications where the input voltage is not well regulated. Fluctuations on the inputs will therefore not affect output voltages, thus driving subsequent downstream components. Non-regulated devices can be used when the upstream signals are well regulated and line changes are minimal.

Output protections can be implemented in the DC-DC converter to prevent damage to the converter or attached loads. One type of protection is for short circuits. Short circuit protection kicks in and shuts down the device when a short circuit condition is created. Typically, once the short is removed, the device will recover to normal operation. Over voltage protection similarly shuts down the DC-DC converter when its voltage exceeds a specified range. Over current or over load protection is a feature that limits the output current so the DC-DC converter will not be damaged. Finally, under voltage lock out is a protection where the device shuts downs when the input voltage drops below a certain level.

Output End

The charging cable can be designed to receive as input an approximate 12V source and output approximately 5V to charge or otherwise power a mobile device.

In some embodiments, the output can be to any of (1) a universal mobile device charger, (2) a dedicated connection for a specific type of mobile device, and/or (3) a standard cigarette lighter receptacle. While the preferred embodiment is a 5V output, any other arbitrary output voltage could be generated by selecting variations of the components used on the PCB.

In some embodiments, output current can be limited to 800 mA, 1 mA, 1.2 mA, or another current appropriate for a mobile device charging standard. Other input and output voltages and currents could be used and generated. Example layouts and designs are illustrated in the figures. The charging cable can perform the function of regulating 5V to a micro USB connector by the circuitry in the PCB.

In some embodiments, the output end can be weather-protected at the interface with the mobile device.

Heat Resistance

Some embodiments of the invention may be used on vehicles with exposed hot points, such as exhausts and engines. In those embodiments, the cable can include heat-resistant features. The material for the cable can be selected to be relatively more heat resistant to the external elements. In some embodiments, the cable assembly can be over-molded with thermoplastic polyurethane with a fluoropolymer elastomer, such as Viton™, heat-shrink over the top to protect against high temperatures. Other types of appropriate heat-resistant materials could also be used.

As a non-limiting example, the cable can be constructed of components including conductors of solid or stranded wire, insulation of silicone rubber, binders of close weave glass tape, electrostatic screens of aluminum and/or polyester laminated tape and a sheath of thermoplastic compound.

The connections can also be made to be secure and resistant to the elements such as large amounts of moisture.

Explanation of Figures

While the illustrated embodiments include the power conversion circuitry as proximate to the source end of the cable and/or integrated into the source connector, in alternative embodiments, the circuitry could be proximate to the output end of the cable and/or integrated into the output connector, or the circuitry could be incorporated into any arbitrary location in or along the cable.

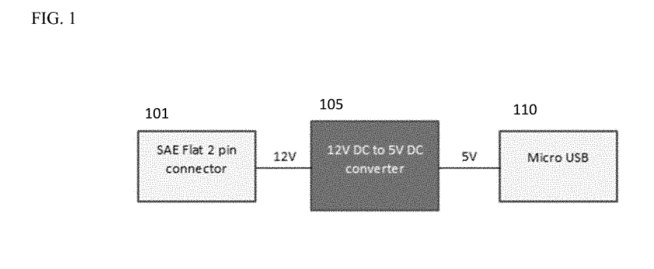

FIG. 1 illustrates a design overview schematic for converting a 12V source to a 5V output. In the illustrated example, the source (101) is an SAE (Society of Automotive Engineers) flat two-pin connector and the output (110) is a micro USB connector. Other types of connectors could be used interchangeably, such as iPhone™ connectors or other proprietary types of connectors. The converter (105) can be configured to convert 12V DC from the source (101) to 5V DC to be supplied to the output (110). The source, converter, and output can be coupled by any appropriate cabling, as described herein. Alternatively, some or all of the components, such as, for example, the output and the converter, can be integrated in a unified housing.

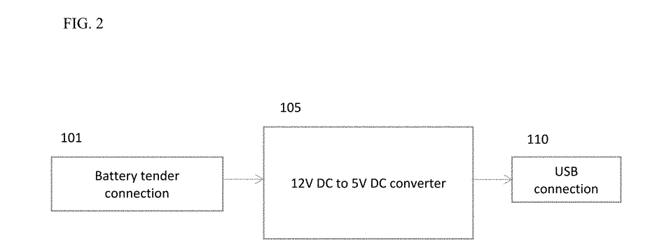

FIG. 2 illustrates a design overview schematic for receiving input power at the source (101) by, in this example, a Battery Tender™ connection and supplying output to a USB connection (110). The Battery Tender™ connection is an example of a type of standardized connection that could be used.

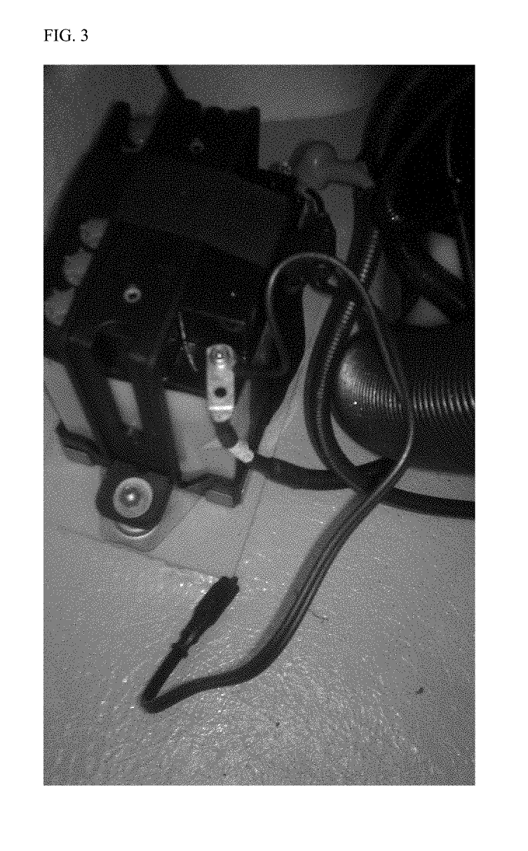

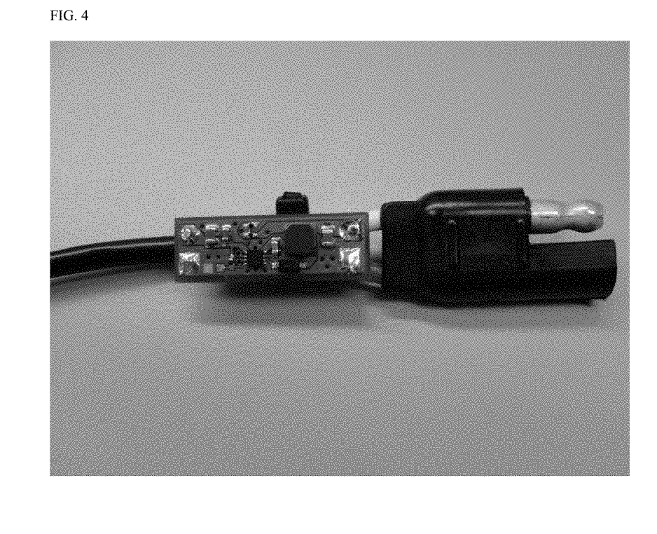

FIG. 3 illustrates a cable connection at the 12V source terminating in a flat-two pin SAE connector.

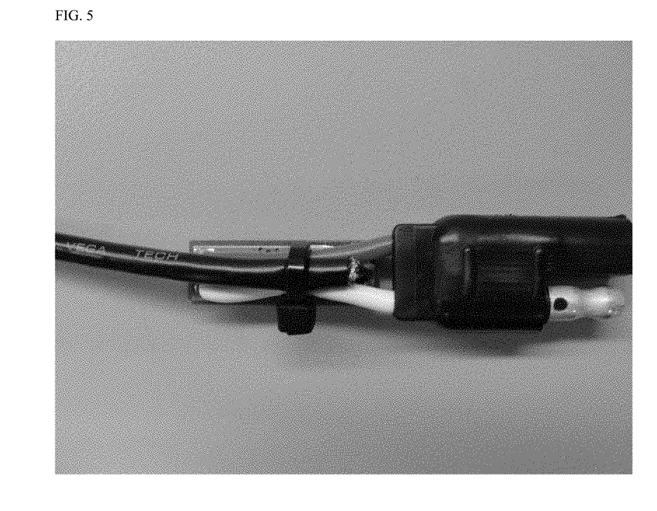

FIG. 4 illustrates a printed circuit board for voltage conversion attached proximate to the flat-two pin SAE connector proximate to the source end of the cable. The printed circuit board could be located at any arbitrary point along the cable between the source and output.

FIG. 5 illustrates another view of a printed circuit board attached proximate to the flat-two pin SAE connector proximate to the source end of the cable.

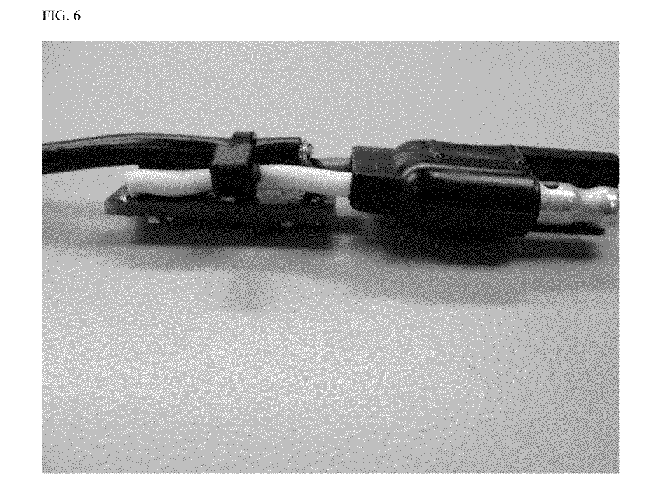

FIG. 6 illustrates another view of a printed circuit board attached proximate to the flat-two pin SAE connector proximate to the source end of the cable.

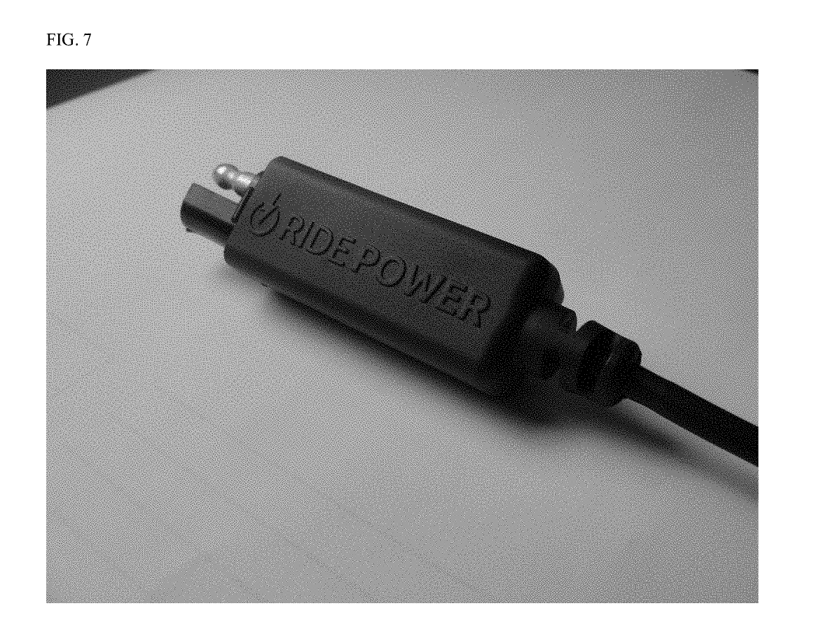

FIG. 7 illustrates a source end comprising a flat two-pin SAE connector for connection to the source. The source, in some embodiments, can be a 12V source. As illustrated, the voltage conversion circuitry can be incorporated into a unified plastic housing at the source end.

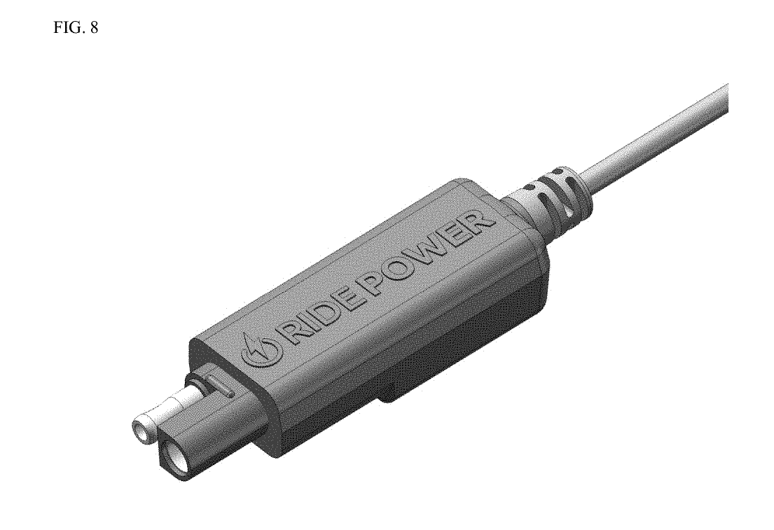

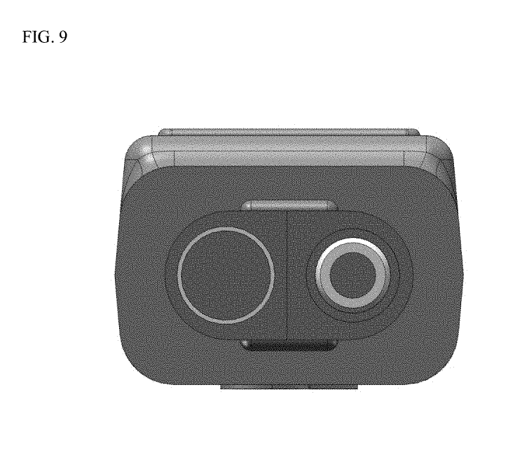

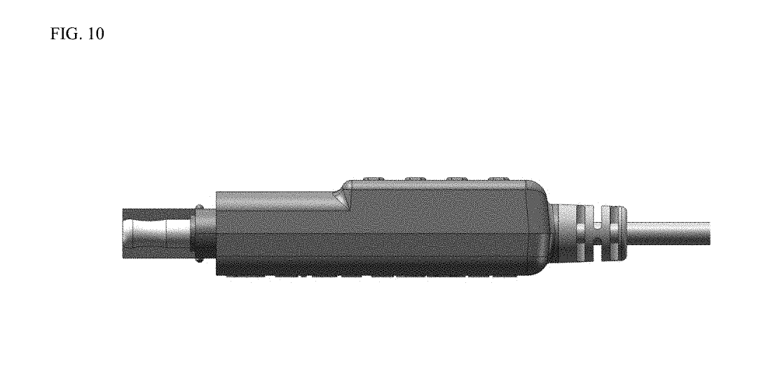

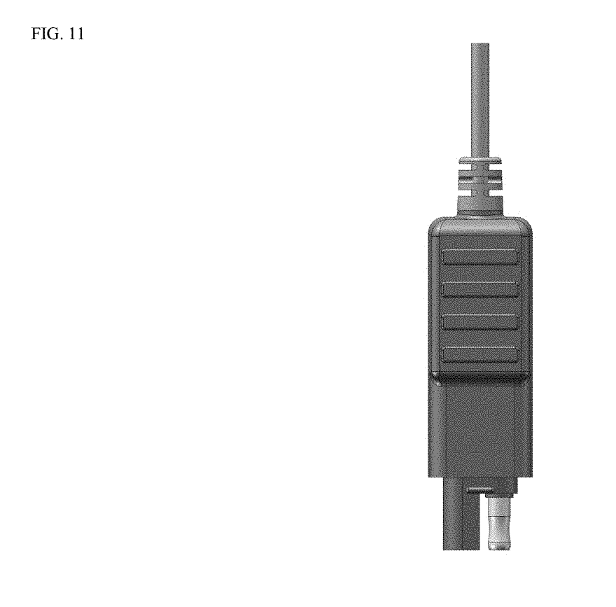

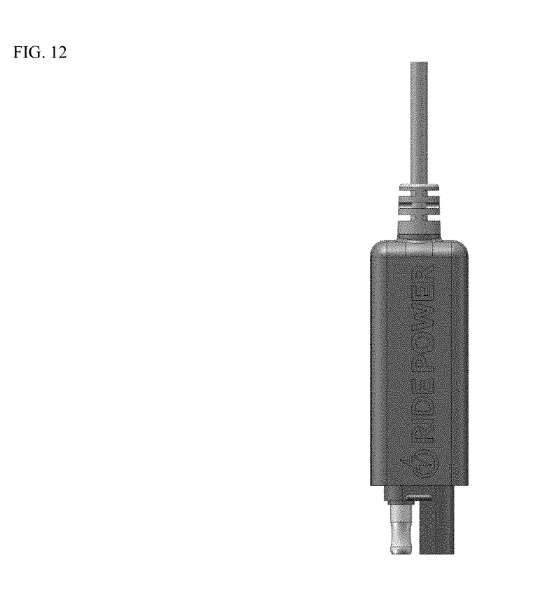

FIGS. 8-12 illustrate views of a source end comprising a flat two-pin SAE connector for connection to the source.

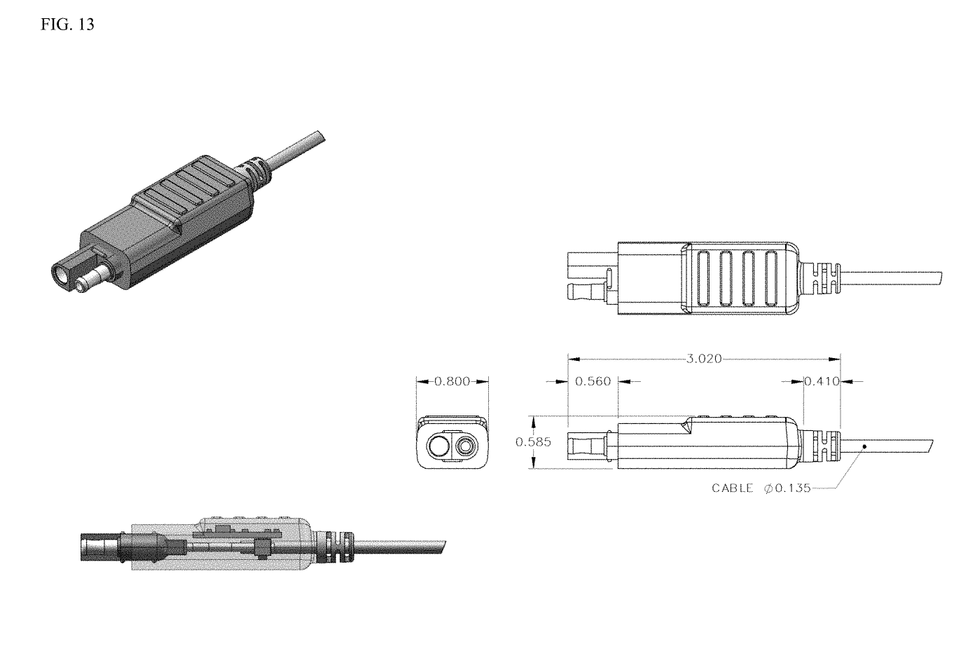

FIG. 13 illustrates a source end comprising a flat two-pin SAE connector for connection to the source, showing placement of circuit board and example dimensions. The dimensions illustrated are particularly selected for use with SAE connectors. If other standardized connectors are used, correspondingly different dimensions may also be used.

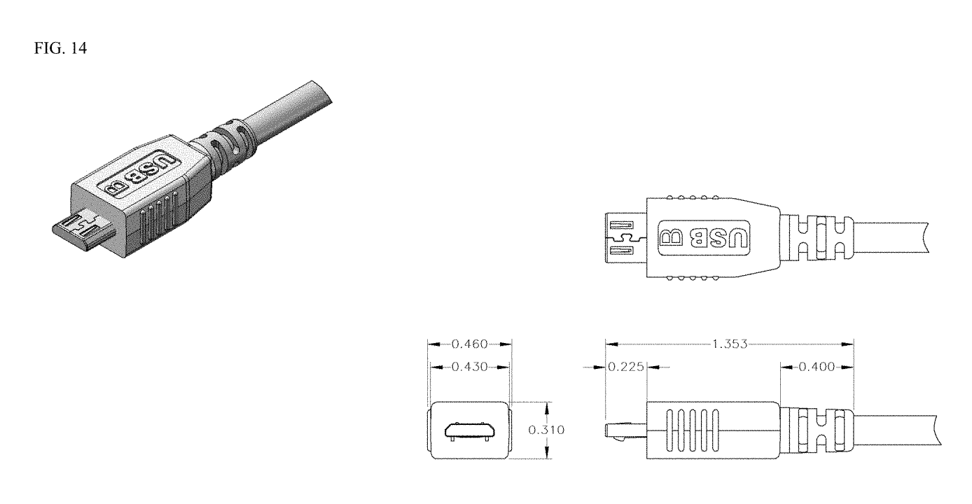

FIG. 14 illustrates an output end formed as a USB B connector, showing example dimensions.

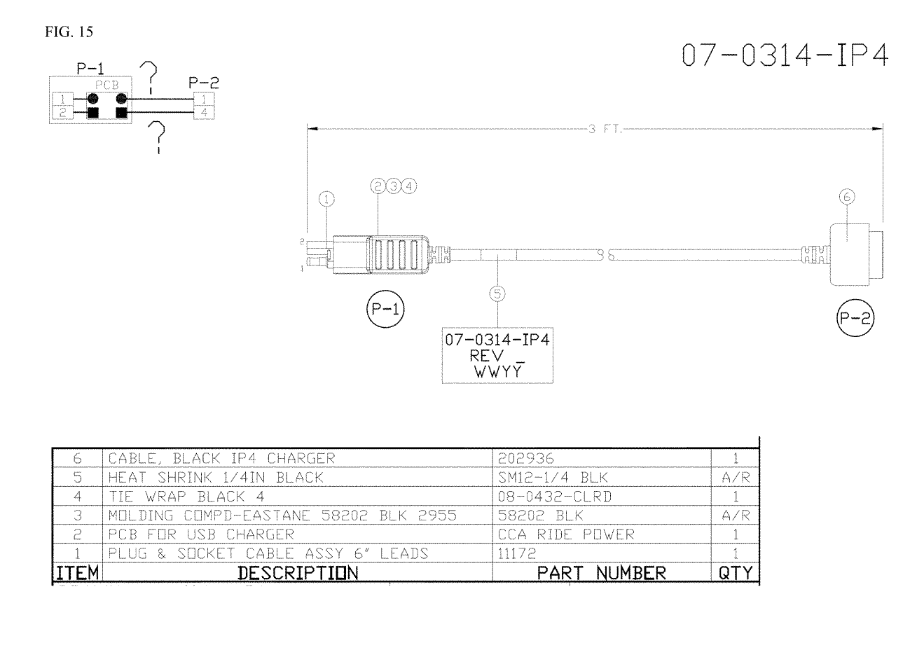

FIG. 15 illustrates a parts diagram showing construction for cable with a flat two-pin SAE connector for connection to the source and terminating in iPhone 4-style connector. An example parts description is provided.

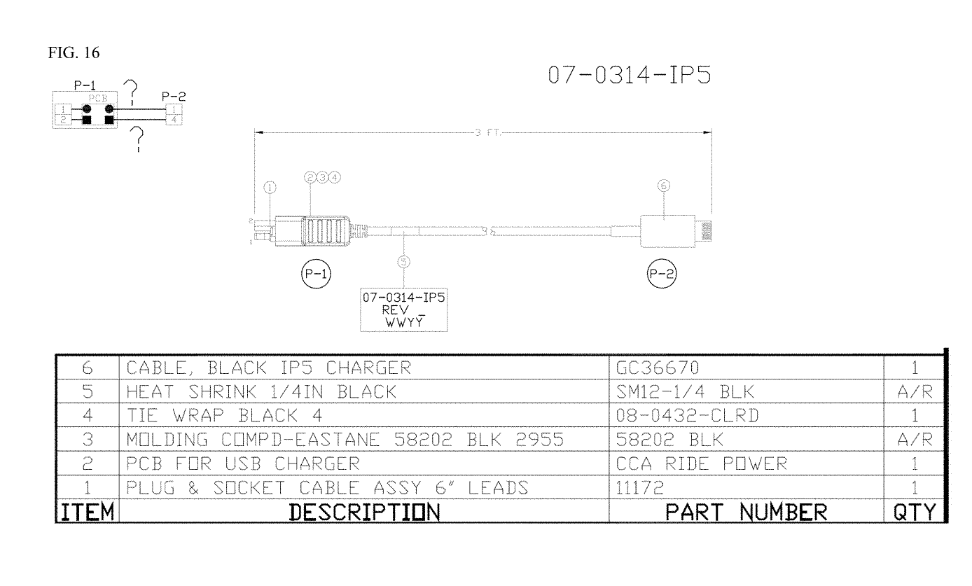

FIG. 16 illustrates a parts diagram showing construction for cable with flat two-pin SAE connector for connection to the 12V source and terminating in iPhone 5 connector. An example parts description is provided.

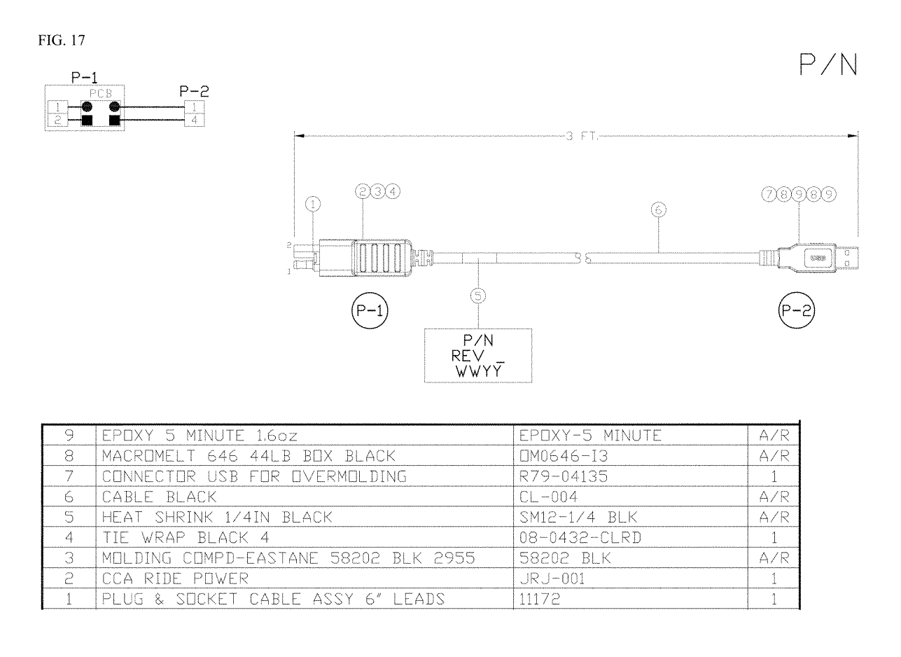

FIG. 17 illustrates a parts diagram showing construction for cable with flat two-pin SAE connector for connection to the 12V source and terminating in a mini-USB connector. An example parts description is provided.

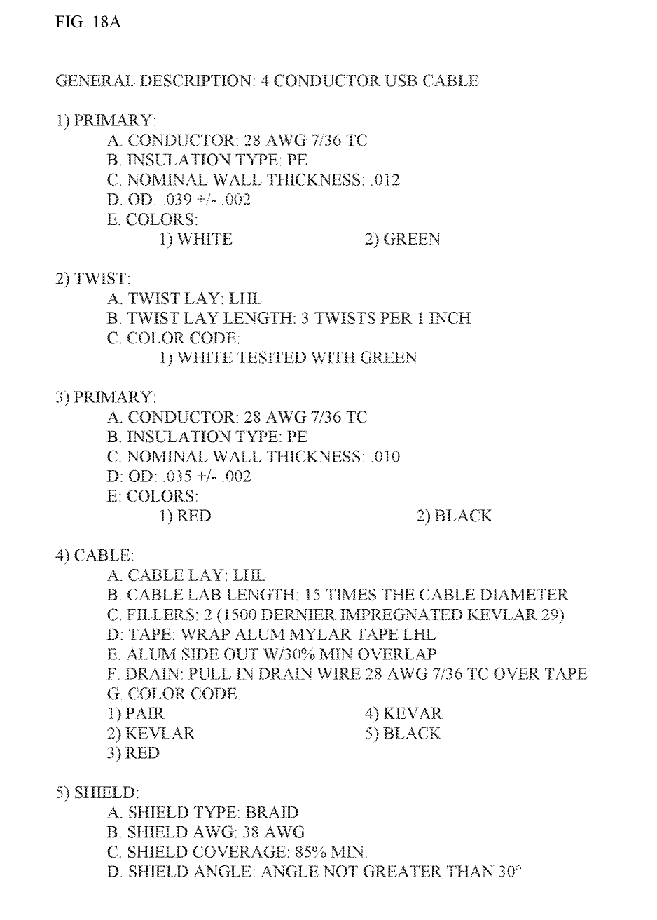

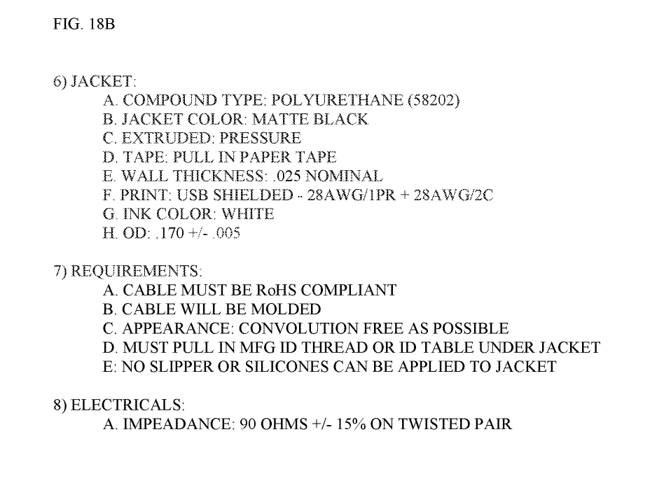

FIGS. 18A-B illustrate a specification for an example four conductor USB cable.

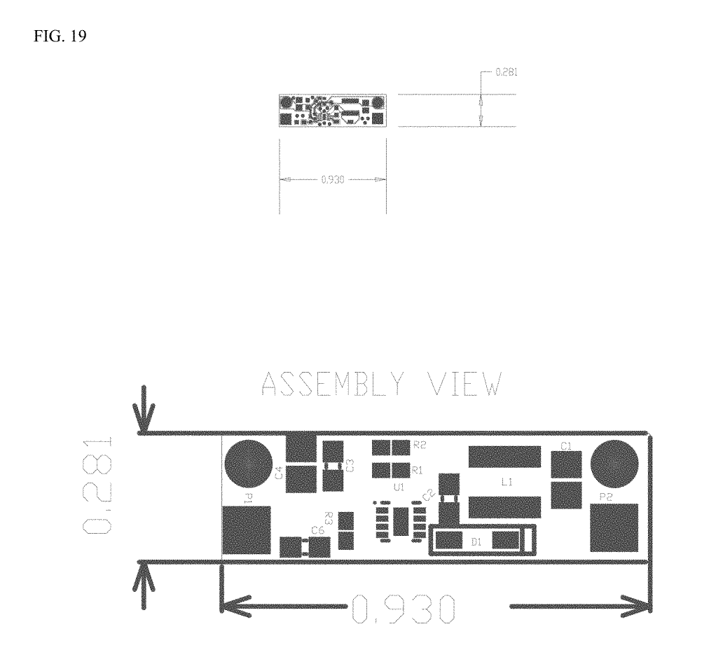

FIG. 19 illustrates an assembly view of the printed circuit board for power conversion.

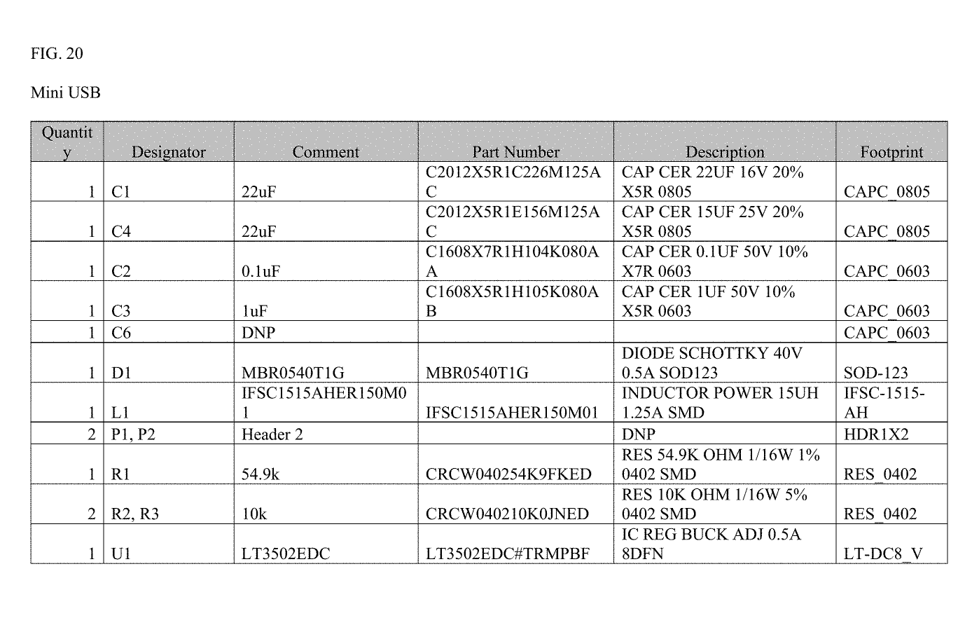

FIG. 20 illustrates an example parts list for the printed circuit board having a mini-USB connection.

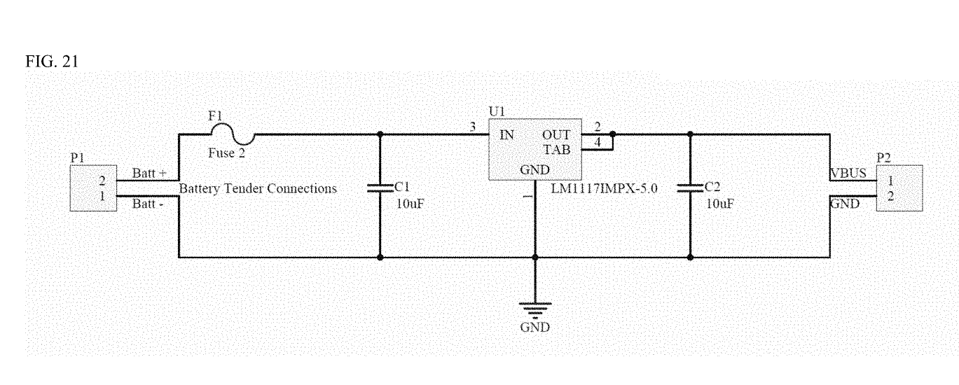

FIG. 21 illustrates an example circuit diagram for the converting the 12V source to the 5V output.

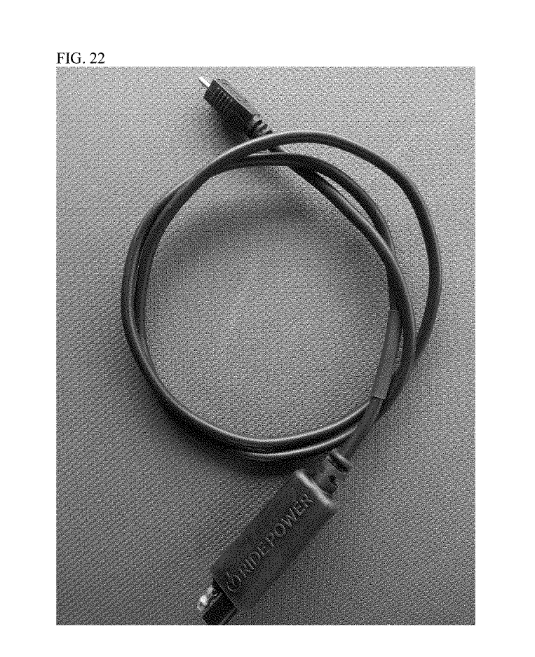

FIG. 22 illustrates an example completed cable having a mini-USB connector at the output.

1. A mobile charger apparatus formed as a cable, the cable comprising:
a first connector at a source end of a mobile charger apparatus formed as a cable, the first connector having a standardized form factor for connection to a wiring harness that is connected to an electrical lead on a vehicle and wherein the first connector is formed as part of the cable and incorporated into a continuous over-molding of the cable;
a second connector at an output end of the charger apparatus cable for electrically connecting a mobile device to the mobile charger apparatus and wherein the second connector is formed as part of the cable and incorporated into the continuous over-molding of the cable;
a power conversion component incorporated into the continuous over-molding of the cable that electrically converts a first voltage received at the first connector to a second voltage and provides the second voltage to the second connector;
wherein the cable connecting the first connector at the source end and the second connector at the output end is constructed as a single, continuous, and electrically sealed apparatus, having continuous over-molding and without further interconnections open to the environment between the source connector and the output connector;
and wherein the cable is constructed from heat-resistant materials.

2. The mobile charger apparatus of claim 1, wherein the cable further comprises a para-aramid synthetic fiber runner.

3. The mobile charger apparatus of claim 2, wherein the para-aramid synthetic fiber runner is Kevlar™.

4. The mobile charger apparatus of claim 1, wherein the cable is constructed so as to withstand a pull force of approximately 100 lbs without breaking.

5. The mobile charger apparatus of claim 1, wherein the first connector interconnects with a Battery Tender™ wiring harness.

6. The mobile charger apparatus of claim 1, wherein the cable is over-molded with thermoplastic polyurethane with a fluoropolymer elastomer heat-shrink to protect against high temperatures.

7. The mobile charger apparatus of claim 1, wherein the cable is constructed of components selected from conductors of solid or stranded wire, insulation of silicone rubber, binders of close weave glass tape, electrostatic screens of aluminum or polyester laminated tape and a sheath of thermoplastic compound.

8. The mobile charger apparatus of claim 1, wherein the first connector is a flat SAE hermaphrodite two-conductor connector.

9. The mobile charger apparatus of claim 1, wherein the first connector comprises components selected from the group consisting of: a circuit board, a resistor, a capacitor, a transistor, a wire, a semiconductor device, and combinations thereof.

10. The mobile charger apparatus of claim 1, wherein the output end is weather-protected at an interface with the mobile device.

11. The mobile charger apparatus of claim 1, wherein the first connector receives electrical power with a voltage of approximately 12V and the second connector provides electrical power with a voltage of approximately 5V.

12. The mobile charger apparatus of claim 1, further comprising one or more batteries connected to the first connector that supply power to the mobile device charger.

13. The mobile charger apparatus of claim 1, wherein at least one of the first and second connectors is an iOS device type connector.

14. The mobile charger apparatus of claim 1, wherein at least one of the first and second connectors is a USB device type connector.

15. The mobile charger apparatus of claim 1, wherein the mobile charger device comprises a flexible cable.
